(19) United States
(12) Patent Application Publication
(10) Pub. No.: US 2026/0123788 A1
(43) Pub. Date: May 7, 2026

(54) LOW STARCH RICE COOKER

(71) Applicant: Keerthi Tenneti, Tarneit (AU)

(72) Inventor: Keerthi Tenneti, Tarneit (AU)

(21) Appl. No.: 19/379,621

(22) Filed: Nov. 4, 2025

Related U.S. Application Data
(60) Provisional application No. 63/716,617, filed on Nov. 5, 2024.

(51) Int. Cl. A47J 36/20

(52) U.S. Cl. CPC A47J 36/20

(57) ABSTRACT

Rice cooked in traditional rice cookers generally produce a significant amount of starch, and the rice cooker disclosed herein reduces the amount of starch in cooked rice by raising cooked rice out of starch rich water after being cooked an appropriate amount by having the cooked rice contained within a strainer structure which is lifted by a lifting mechanism.

### CROSS REFERENCE TO RELATED APPLICATIONS

This U.S. Non-Provisional Patent Application claims the benefit of and priority to U.S. Provisional Ser. No. 63/716,617, filed on Nov. 5, 2024, titled “LOW STARCH RICE COOKER”, by inventor Keerthi Tenneti, the contents of which are expressly incorporated herein by this reference as though set forth in their entirety and to which priority is claimed.

### FIELD OF USE

The present disclosure relates generally to the field of cooking appliances, and more specifically, to low starch rice cookers.

### BACKGROUND

Rice is a staple food consumed by billions of people worldwide, and its preparation methods vary significantly across different cultures and regions. Among these methods, the use of rice cookers has become increasingly popular due to their convenience and ability to consistently produce well-cooked rice. Rice cookers automate the cooking process, allowing users to prepare rice with minimal effort and attention. Despite their widespread use and convenience, rice cookers often present a particular problem: the cooked rice tends to contain excessive amounts of starch.

Starch is a major component of rice, and while it is an important source of carbohydrates, excessive starch in cooked rice can lead to several undesirable outcomes. One of the primary issues is the change in texture; rice with too much starch can become overly sticky, gummy, and clumpy, which is not desirable for many culinary applications. This issue is particularly problematic for dishes that require distinct, separate grains of rice, such as fried rice or certain types of pilafs.

Furthermore, the presence of excess starch in cooked rice can have nutritional and health implications. High starch content can contribute to a higher glycemic index, which may not be suitable for individuals managing blood sugar levels, such as those with diabetes. Additionally, some people may prefer or require lower starch content in their diet for various health reasons.

Another concern is the potential impact on the flavor and overall eating experience. Excess starch can mask the natural flavors of the rice and any accompanying ingredients, leading to a less enjoyable meal. This can be particularly disappointing for those who seek to appreciate the subtle flavors of different rice varieties or who are preparing rice as part of a more complex dish.

Moreover, the problem of excess starch is not limited to the culinary and nutritional aspects. It can also affect the cleaning and maintenance of rice cookers. Starchy residues can adhere to the inner pot and other components of the rice cooker, making it more difficult to clean and potentially leading to the buildup of residue over time. This can affect the longevity and performance of the appliance.

Thus, what is needed is a rice cooker that automatically cooks rice in such a way to reduce or remove starch from the final product.

### SUMMARY

To minimize the limitations in the cited references, and to minimize other limitations that will become apparent upon reading and understanding the present specification relates to a low starch rice cooker.

One embodiment may be a low starch rice cooker, comprising: a base; a pot; a lifting basket; and a lifting device; wherein the lifting basket comprises a strainer and a handle. The strainer may comprise a strainer height; wherein the pot may comprise a pot height; and wherein the strainer height is less than the pot height. The lifting basket may comprise a strainer-handle attachment portion configured to extend upward from the strainer and connect to the handle. When the strainer is within the pot, the handle is preferably outside the pot. The base may comprise the lifting device; and the lifting device may extend upward from the base and is configured to engage the handle. The lifting device may be configured to actuate upward and raise the handle, thereby raising the strainer relative to the pot. In an alternative embodiment, the lifting device may be configured to rotate via a screw and thread mechanism to raise the handle, thereby raising the strainer relative to the pot. The lifting device may extend upward from the pot and is configured to engage the handle. The lifting device may be configured to actuate upward and raise the handle, thereby raising the strainer relative to the pot. The handle may extend radially outward and then vertically. The base may comprise a control board. The low starch rice cooker may comprise a cover; wherein the cover may comprise a vent and a handle opening. The cover may be configured to engage the pot along a substantial portion of a circumference of the pot.

One embodiment of the device of the present disclosure may be an electrical appliance that is similar to a conventional rice cooker but eliminates the starch content in cooked rice.

When rice is cooked it releases starch. This starch gets diluted in the water that is used to cook the rice. This starchy water is removed after the rice may be cooked to the desired doneness.

In one embodiment, after the starchy water is removed, water without starch (remaining or new) may be used to further cook the rice.

In one embodiment, a timer may be used to determine when to remove the starchy water from the rice. In other embodiments, the user may manually start the removal of the starchy water.

In one embodiment, the rice cooker of the present disclosure may have a strainer that may matingly fit the main rice cooker vessel. At the appropriate time, the strainer rises and removes the rice from the starchy water, which remains in the main rice cooker vessel. Since the starchy water is higher in density than the regular water, the starchy water gathers at the bottom of the rice cooker. Thus, when the strainer rises, the starchy water is left behind in the main rice cooker vessel.

In one embodiment, the starchy water may then be automatically or manually drained from the main rice cooker vessel.

The rice that is lifted out of the starchy water is now ready to be served and provides a rice that is much lower in starch than rice cooked in a conventional rice cooker.

Other features and advantages inherent in the device for cooking rice, besides those which are claimed and disclosed, will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an exploded view of one embodiment of a rice cooker.

FIG. 2 is an exploded view of one embodiment of a rice cooker.

FIG. 3 is an illustration of one embodiment of a rice cooker.

FIG. 4 is an illustration of one embodiment of a lifting device in a lower position.

FIG. 5 is an illustration of one embodiment of a lifting device in an upper position.

FIG. 6 is an illustration of one embodiment of a lifting basket.

### DETAILED DESCRIPTION OF THE DRAWINGS

In the following detailed description, numerous specific details are set forth in order to provide a thorough understanding of various aspects of one or more embodiments. However, these embodiments may be practiced without some or all of these specific details. In other instances, well-known methods, procedures, and/or components have not been described in detail so as not to unnecessarily obscure aspects of embodiments.

While multiple embodiments are disclosed, still other embodiments will become apparent to those skilled in the art from the following detailed description. As will be realized, these embodiments are capable of modifications in various obvious aspects, all without departing from the spirit and scope of protection. Accordingly, figures and the detailed descriptions thereof are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about,” may refer to a deviance of between 0.0001-10% from the indicated number or range of numbers.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

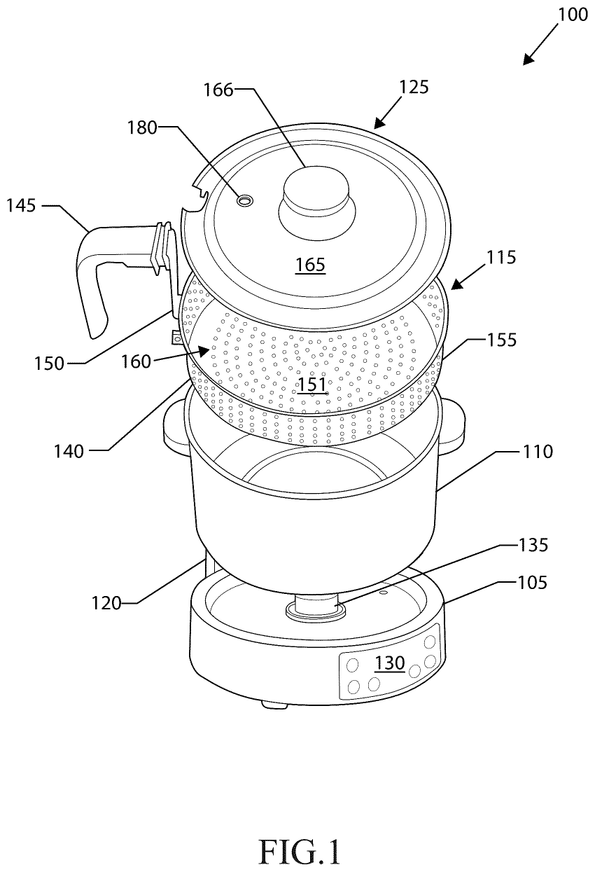

FIG. 1 is an exploded view of one embodiment of a rice cooker. As shown in FIG. 1, the rice cooker 100 may comprise, a base 105, a pot 110, a lifting basket 115, a lifting device 120, and a cover 125.

In one embodiment, the base 105 may act to support the pot 110 and house many, if not all, electronic components of the rice cooker 100. The base 105 may comprise a control board, which may be operated by a user through an interface panel 130. In one embodiment the base 105 may also comprise a lifting device 120. The base 105 may also comprise a heating component 135 configured to heat up the pot 110 in order to heat up water contained within the pot 110, to cook rice contained within the lifting basket 115.

In one embodiment, the pot 110 may be a material that allows heat and/or induction derived heat generated by the base 105 to be transferred into water contained within the pot 110. In a preferred embodiment, the pot 110 is impermeable to water. In some embodiments, the pot 110 may be insulated to reduce lost heat.

The lifting basket 115 may comprise a strainer 140 and a handle 145. The strainer 140 and the handle 145 may be connected via a strainer-handle attachment portion 150. The strainer-handle attachment portion 150 may be configured to extend upward from the strainer 140 and connect to the handle 145. The strainer 140 may comprise a floor 151 and outer wall 155 that comprise a plurality of holes 160. In alternative embodiments, the plurality of holes 160 may be replaced with substantially any structure that would allow for water, but not rice, to pass through it. In a preferred embodiment the strainer 140 floor 151 and outer wall 155 may be configured to rest within the pot 110, such that water in the pot 110 may enter the strainer 140 or be within the strainer 140 when the strainer 140 is in a lower position, and such that the water drains out of the strainer 140 when the strainer 140 is in an upper position. In some embodiments, the handle 145 may be any portion of the lifting basket 115 outside the pot 110.

The lifting device 120 may be configured to engage a portion of the handle 145 and raise the handle 145, thereby raising the strainer 140 to the upper position. In one embodiment, the lifting device 120 may be a component of the base 105. In one embodiment the lifting device 120 may be a vertically actuating device, such as a device comprising a piston type mechanism. In other embodiments the lifting device 120 may comprise a gear type mechanism. The lifting device 120 may be configured to extend upward or downward to raise or lower the lifting basket 115.

The cover 125 may comprise a lid 165 and a knob 166. The lid 165 may be substantially circular, with a cut out to allow the handle 145 of the lifting basket 115 to traverse the lid 165 and connect to the strainer-handle attachment portion 150 so that the handle 145 may extend outward from the upper portion of the pot 110. The cover 125 may also comprise a vent 180.

In a preferred embodiment, a user may place rice to be cooked within the strainer 140, and place the strainer 140 within the pot 110. The user may then, or before, add water to the pot 110 sufficient to fully cook the rice, along with an additional amount of water. At this stage the lifting basket 115 is preferably in the lower position. The rice cooker 100 may then heat the water by using the heating component 135 to heat the pot 110, thereby cooking the rice, for a predetermined amount of time depending on the amount of rice and/or water in the pot 110. When the rice is properly cooked, which may be determined based on a predetermined amount of time passed, the lifting device 120 may actuate from the lower position to the upper position, thereby raising the lifting basket 115 to a raised position, such that water leftover from the cooking process is no longer in contact with the cooked rice, and excess water drains through the strainer 140 into the pot 110. In this way, excess starch generated through cooking the rice is separated from the rice, thereby reducing the amount of starch in the cooked rice.

In some embodiments, the control board may determine the amount of heat generated, the length of time that heat is generated, and determine when to adjust the lifting basket 115 from a lower position to an upper position by raising or extending the lifting device 120, or adjusting the lifting basket 115 from an upper position to a lower position by retracting or lowering the lifting device 120. The user may input commands to be relayed to the control board via the interface panel 130.

In one embodiment, the strainer 140 may comprise a strainer height and the pot 110 may comprise a pot height; wherein the strainer height is less than the pot height. In alternative embodiments, the strainer height may be equal to or greater than the pot height.

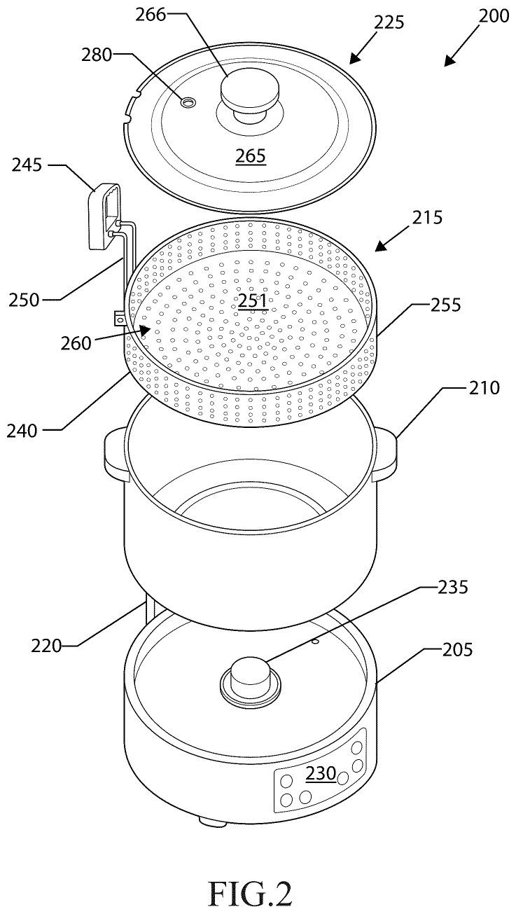

FIG. 2 is an exploded view of one embodiment of a rice cooker. As shown in FIG. 2, the rice cooker 200 may comprise, a base 205, a pot 210, a lifting basket 215, a lifting device 220, and a cover 225.

In one embodiment, the base 205 may act to support the pot 210 and house many, if not all, electronic components of the rice cooker 200. The base 205 may comprise a control board, which may be operated by a user through an interface panel 230. In one embodiment the base 205 may also comprise a lifting device 220. The base 205 may also comprise a heating component 235 configured to heat up the pot 210 in order to heat up water contained within the pot 210, to cook rice contained within the lifting basket 215.

In one embodiment, the pot 210 may be a material that allows heat and/or induction derived heat generated by the base 205 to be transferred into water contained within the pot 210. In a preferred embodiment, the pot 210 is impermeable to water. In some embodiments, the pot 210 may be insulated to reduce lost heat.

The lifting basket 215 may comprise a strainer 240 and a handle 245. The strainer 240 and the handle 245 may be connected via a strainer-handle attachment portion 250. The strainer-handle attachment portion 250 may be configured to extend upward from the strainer 240 and connect to the handle 245. The strainer 240 may comprise a floor 251 and outer wall 255 that comprise a plurality of holes 260. In alternative embodiments, the plurality of holes 260 may be replaced with substantially any structure that would allow for water, but not rice, to pass through it. In a preferred embodiment the strainer 240 floor 251 and outer wall 255 may be configured to rest within the pot 210, such that water in the pot 210 may enter the strainer 240 or be within the strainer 240 when the strainer 240 is in a lower position, and such that the water drains out of the strainer 240 when the strainer 240 is in an upper position. In some embodiments, the handle 245 may be any portion of the lifting basket 215 outside the pot 210.

The lifting device 220 may be configured to engage a portion of the handle 245 and raise the handle 245, thereby raising the strainer 240 to the upper position. In one embodiment, the lifting device 220 may be a component of the base 205. In one embodiment the lifting device 220 may be a vertically actuating device, such as a device comprising a piston type mechanism. In other embodiments the lifting device 220 may comprise a gear type mechanism. The lifting device 220 may be configured to extend upward or downward to raise or lower the lifting basket 215.

The cover 225 may comprise a lid 265 and a knob 266. The lid 265 may be substantially circular, with a cut out to allow the handle 245 of the lifting basket 215 to traverse the lid 265 and connect to the strainer-handle attachment portion 250 so that the handle 245 may extend outward from the upper portion of the pot 210. The cover 225 may also comprise a vent 280.

In a preferred embodiment, a user may place rice to be cooked within the strainer 240, and place the strainer 240 within the pot 210. The user may then, or before, add water to the pot 210 sufficient to fully cook the rice, along with an additional amount of water. At this stage the lifting basket 215 is preferably in the lower position. The rice cooker 200 may then heat the water by using the heating component 235 to heat the pot 210, thereby cooking the rice, for a predetermined amount of time depending on the amount of rice and/or water in the pot 210. When the rice is properly cooked, which may be determined based on a predetermined amount of time passed, the lifting device 220 may actuate from the lower position to the upper position, thereby raising the lifting basket 215 to a raised position, such that water leftover from the cooking process is no longer in contact with the cooked rice, and excess water drains through the strainer 240 into the pot 210. In this way, excess starch generated through cooking the rice is separated from the rice, thereby reducing the amount of starch in the cooked rice.

In some embodiments, the control board may determine the amount of heat generated, the length of time that heat is generated, and determine when to adjust the lifting basket 215 from a lower position to an upper position by raising or extending the lifting device 220, or adjusting the lifting basket 215 from an upper position to a lower position by retracting or lowering the lifting device 220. The user may input commands to be relayed to the control board via the interface panel 230.

In one embodiment, the strainer 240 may comprise a strainer height and the pot 210 may comprise a pot height; wherein the strainer height is less than the pot height. In alternative embodiments, the strainer height may be equal to or greater than the pot height.

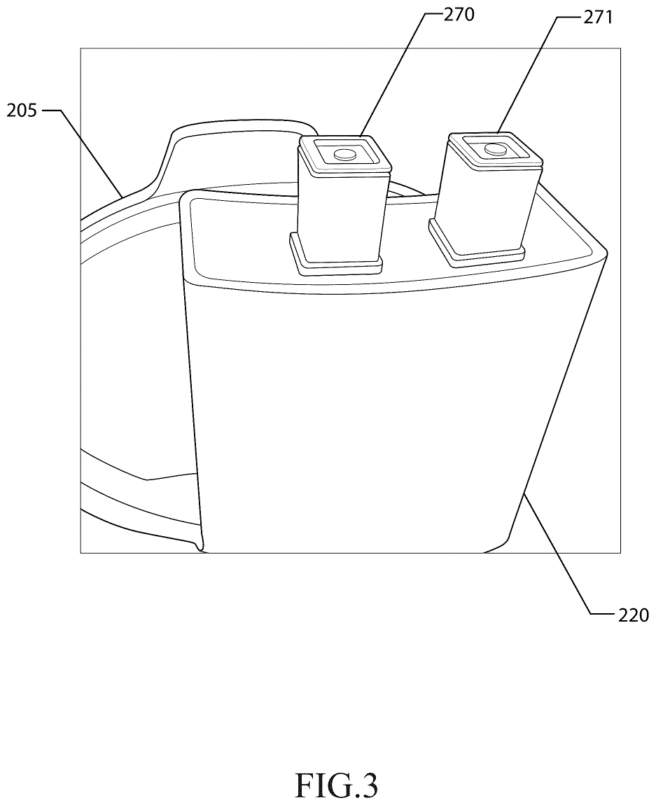

FIG. 3 is an illustration of one embodiment of a rice cooker. As shown in FIG. 2, the rice cooker 200 may have substantially similar components as rice cooker 100. One notable difference is the shape of the handle 245 relative to handle 145 as well as strainer-handle attachment portion 250 relative to strainer-handle attachment portion 150.

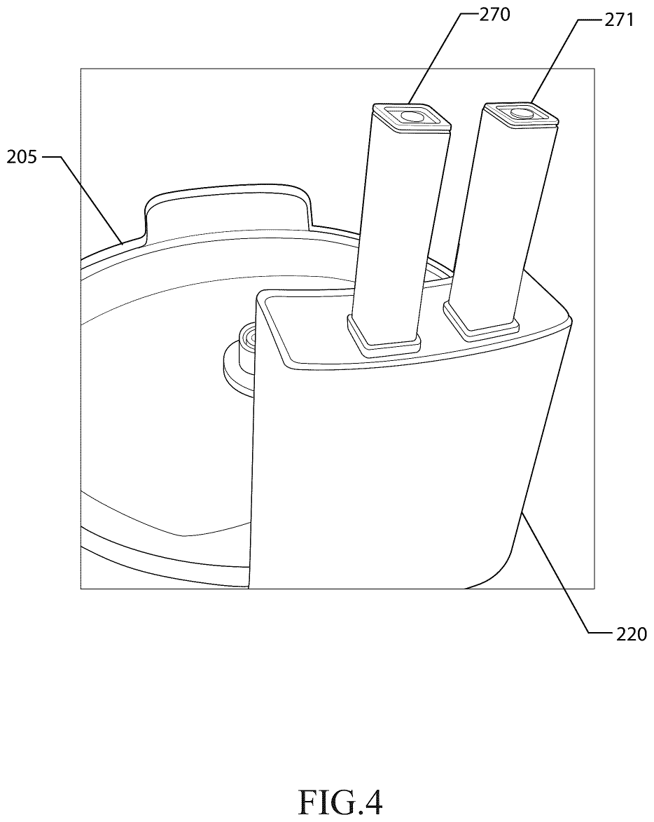

FIG. 4 is an illustration of one embodiment of a lifting device in a lower position. As shown, the lifting device 220 may comprise two lifting supports 270, 271 configured to engage portions of the handle, which may be referred to as lifting receivers 275, 276. In alternate embodiments, there may be different numbers of lifting supports.

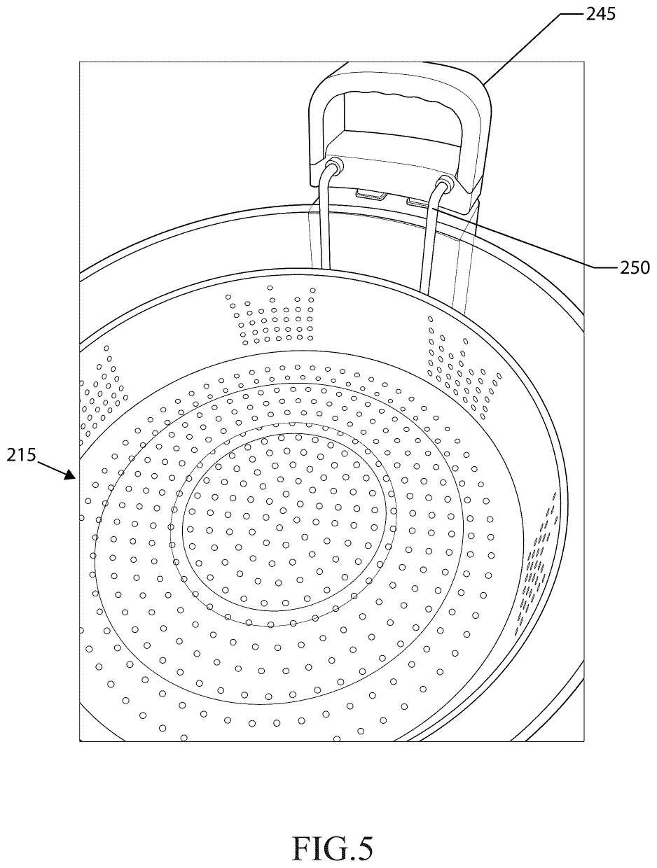

FIG. 5 is an illustration of one embodiment of a lifting device in an upper position.

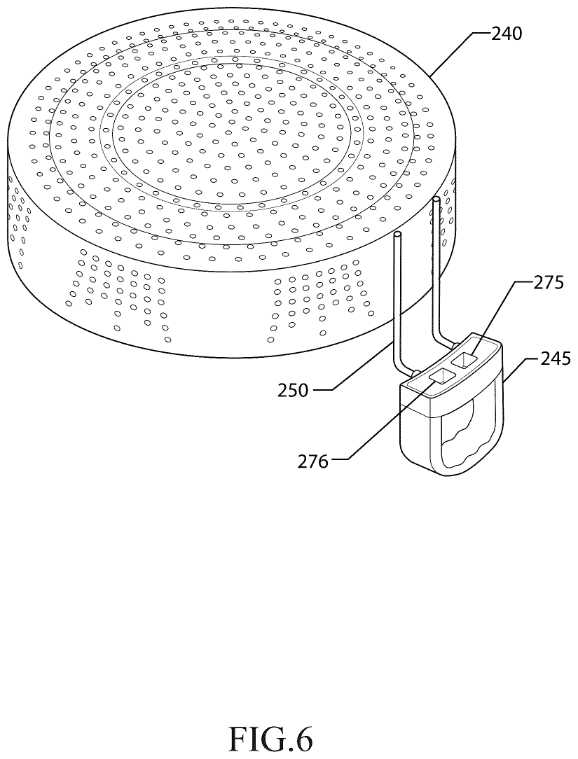

FIG. 6 is an illustration of one embodiment of a lifting basket. As shown in FIG. 6, the lifting basket 215 may comprise lifting receivers 275, 276 configured to receive the lifting supports 270, 271.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded as illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A low starch rice cooker, comprising:
a base;
a pot;
a lifting basket; and
a lifting device;
wherein said lifting basket comprises a strainer and a handle.

2. The low starch rice cooker of claim 1, wherein said strainer comprises a strainer height;
wherein said pot comprises a pot height; and
wherein said strainer height is less than said pot height.

3. The low starch rice cooker of claim 2, wherein said lifting basket comprises a strainer-handle attachment portion configured to extend upward from said strainer and connect to said handle.

4. The low starch rice cooker of claim 3, wherein when said strainer is within said pot, said handle is outside said pot.

5. The low starch rice cooker of claim 4, wherein said base comprises said lifting device; and
wherein said lifting device extends upward from said base and is configured to engage said handle.

6. The low starch rice cooker of claim 5, wherein said lifting device is configured to actuate upward and raise said handle, thereby raising said strainer relative to said pot.

7. The low starch rice cooker of claim 5, wherein said lifting device is configured to rotate via a screw and thread mechanism to raise said handle, thereby raising said strainer relative to said pot.

8. The low starch rice cooker of claim 6, wherein said lifting device extends upward from said pot and is configured to engage said handle.

9. The low starch rice cooker of claim 6, wherein said lifting device is configured to actuate upward and raise said handle, thereby raising said strainer relative to said pot.

10. The low starch rice cooker of claim 1, wherein said handle extends radially outward and then vertically.

11. The low starch rice cooker of claim 1, wherein said base comprises a control board.

12. The low starch rice cooker of claim 1, further comprising a cover;
wherein said cover comprises a vent and a handle opening.

13. The low starch rice cooker of claim 12, wherein said cover is configured to engage said pot along a substantial portion of a circumference of said pot.
